(19) United States
(12) Patent Application Publication
(10) Pub. No.: US 2018/0109161 A1
(43) Pub. Date: Apr. 19, 2018

(54) MOTOR WITH DIFFERENTIAL MATCHING GEAR

(71) Applicant: HARMONIC INNOVATION TECHNOLOGY CO., LTD., Taipei City (TW)

(72) Inventor: Chun-Shen YEH, Taipei City (TW)

(21) Appl. No.: 15/821,924

(22) Filed: Nov. 24, 2017

Related U.S. Application Data
(63) Continuation-in-part of application No. 14/588,210, filed on Dec. 31, 2014.

(30) Foreign Application Priority Data
Aug. 5, 2014 (TW) 103126736

(51) Int. Cl. H02K 7/116; F16H 1/32

(52) U.S. Cl. CPC H02K 7/116; F16H 1/32

(57) ABSTRACT

The present invention provides a motor with differential matching gear. This motor comprises a stator, a rotor, an externally inner gear, an internally outer gear, an output shaft, and a motor housing. The stator produces magnetic lines of force, causing the rotor to rotate at a first revolving speed. The rotor has an asymmetric wall thickness configuration. The externally inner gear has a plurality of inner teeth. The rotor dynamically changes the axle center of the externally inner gear by moving it when rotating. The internally outer gear has a plurality of outer teeth. The inner teeth partially mesh the outer teeth when the externally inner gear rotates; and the axle center of the internally outer gear remains unchanged when the internally outer gear rotates. The output shaft is driven by the internally outer gear so that it rotates at a second revolving speed less than the first revolving speed.

### CROSS-REFERENCE TO RELATED APPLICATIONS

This application is a Continuation-in-Part of co-pending application Ser. No. 14/588,210, filed on Dec. 31, 2014, for which priority is claimed under 35 U.S.C. § 120; and this application claims priority of Application No. 103126736 filed in Taiwan on Aug. 5, 2014 under 35 U.S.C. § 119; the entire contents of all of which are hereby incorporated by reference.

### FIELD OF THE INVENTION

This invention relates to a motor and, more particularly, to a motor with differential matching gear having high torque output.

### BACKGROUND OF THE INVENTION

Traditionally, the normal motor would incorporate a speed reducer to increase the torque output and lower the speed. Or, the user can use a multiple-magnetic-pole low-speed motor directly.

However, the conventional motor is very disadvantageous. Because they are huge, heavy and expensive.

Accordingly, the present invention provides a motor with differential matching gear to solve the disadvantages of the conventional motor.

### SUMMARY OF THE INVENTION

One of the purposes of the present invention is to provide a motor with differential matching gear that generates high torque output by incorporating a speed reducer into a low-power motor.

The second purpose of the present invention is to provide a motor with differential matching gear that is compact, light and cost effective.

The third purpose of the present invention is to provide a motor with differential matching gear that can be employed in AC/DC synchronous or asynchronous motor.

The fourth purpose of the present invention is to provide a motor with differential matching gear incorporating a speed reducer composed of an externally inner gear and an internally outer gear. Furthermore, a reduction ratio is determined by adjusting the number of teeth on the externally inner gear and the number of teeth on the internally outer gear.

The present invention discloses a motor with differential matching gear. The motor with differential matching gear comprises a stator, a rotor connected to the stator, an externally inner gear connected to the rotor, an internally outer gear connected to the externally inner gear, an output shaft connected to the internally outer gear, and a motor housing for accommodating all the aforementioned components. The stator produces magnetic lines of force, causing the rotor to rotate at a first revolving speed. The rotor has an uneven wall thickness. The externally inner gear has a plurality of inner teeth. The rotor dynamically changes the axle center of the externally inner gear by moving the externally inner gear when rotating. The internally outer gear has a plurality of outer teeth. The inner teeth partially mesh the outer teeth when the externally inner gear rotates; the axle center of the internally outer gear remains unchanged when the internally outer gear rotates. The output shaft is driven by the internally outer gear so that it rotates at a second revolving speed less than the first revolving speed.

In another embodiment of the present invention discloses a motor with differential matching gear. The motor with differential matching gear comprises a stator, a rotor connected to the stator, an internally outer gear connected to the rotor, an externally inner gear connected to the internally outer gear, an output plate connected to the externally inner gear, and a motor housing for accommodating all the aforementioned components. The stator produces magnetic lines of force, causing the rotor to rotate at a first revolving speed. The rotor has an uneven wall thickness. The internally outer gear has a plurality of outer teeth. The rotor dynamically changes the axle center of the internally outer gear by moving the internally outer gear when rotating. The externally inner gear has a plurality of inner teeth. The outer teeth partially mesh the inner teeth when the internally outer gear rotates; the axle center of the externally inner gear remains unchanged when the externally inner gear rotates. The output plate is driven by the externally inner gear so that it rotates at a second revolving speed less than the first revolving speed.

Comparing to the conventional motor, the present invention provide a motor with differential matching gear. The motor can use a low-power motor incorporating a speed reducer, composed by an internally outer gear and an externally inner gear, to generate high torque output.

Because the small speed reducer can be incorporated into the low-power motor, therefore the low-power motor can make a compact electric machine with high torque. This electric machine, for example, can be employed in an electric mobile or an electric bike.

### BRIEF DESCRIPTION OF THE DRAWINGS

FIGS. 1(a) and 1(b) are schematic exploded views of a motor with differential matching gear according to a first embodiment of the present invention.

FIG. 2 is a schematic cross-sectional view of the motor with differential matching gear taken along line A-A′ shown in FIG. 1(b).

FIG. 3 is a schematic exploded view of a motor with differential matching gear according to a second embodiment of the present invention.

### DETAILED DESCRIPTION OF THE INVENTION

The advantages and features of the present invention can be further clarified by the following descriptions and attached drawings.

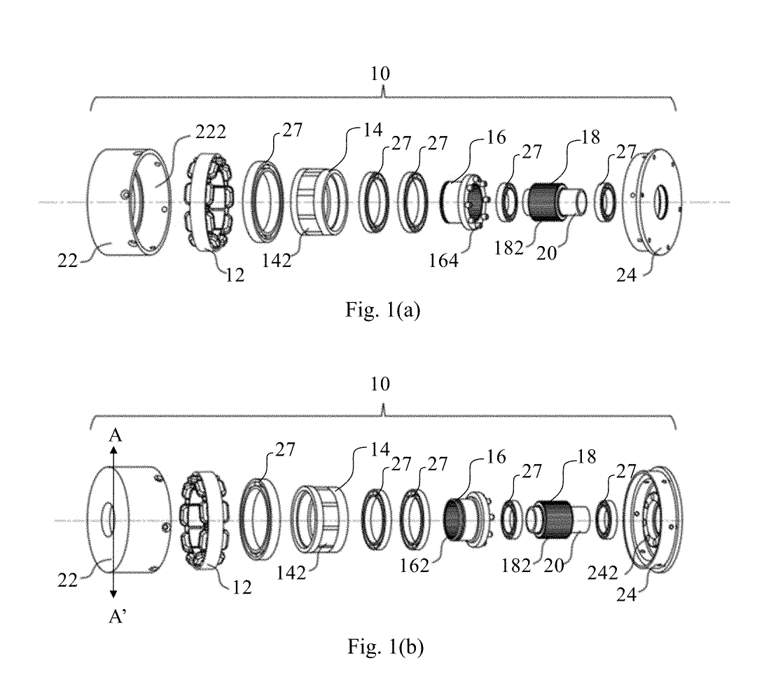

The FIG. 1(a), (b) shows a schematic exploded view of a motor with differential matching gear according to a first embodiment of the present invention. In FIG. 1(a), (b), the motor with differential matching gear 10 comprises a stator 12, a rotor 14, an externally inner gear 16, an internally outer gear 18, an output shaft 20, and a motor housing 22 for accommodating all the aforementioned components. The motor with differential matching gear 10 can be driven by a DC power supply or an AC power supply. Additionally, the motor with differential matching gear 10 can be classified as a synchronous or an asynchronous motor depending on how the stator 12 and the rotor 14 are arranged. For example, the synchronous motor includes the stator 12 composed of coils and the rotor 14 composed of field magnets; the asynchronous motor includes the stator 12 composed of coils and the rotor 14 composed of coils. Furthermore, the motor with differential matching gear 10 can be classified as an inner rotor electric machine or an outer rotor electric machine depending on the way it outputs.

In this embodiment, the motor with differential matching gear 10 is an inner rotor electric machine.

The motor housing 22 has an accommodation space 222 for accommodating the stator 12, the rotor 14, the externally inner gear 16, the internally outer gear 18, and the output shaft 20.

The stator 12 is used to produce magnetic lines of force.

The rotor 14 is connected to the stator 12, and has multiple field magnets 142. The magnetic lines of force drive the rotor to rotate at a first revolving speed. It is noted that the wall thickness 140, 141 of the rotor 14 is asymmetric.

The externally inner gear 16 is connected to the rotor 14, and has multiple inner teeth 162. Note that the rotor 14 dynamically changes the axle center of the externally inner gear 16 by moving the externally inner gear 16 when rotating. In this embodiment, the externally inner gear 16 rotates eccentrically because not only multiple constraint columns 164 of the externally inner gear 16 are inserted into multiple constraint holes 242 of an outer housing 24 but also the constraint columns 164 are confined to rotate in the constraint holes 242 due to the asymmetric wall thickness configuration 140, 141 of the rotor 14.

The internally outer gear 18 is connected to the externally inner gear 16, and has multiple outer teeth 182. The inner teeth 162 partially mesh the outer teeth 182 when the externally inner gear 16 rotates. Note that the axle center of the internally outer gear 18 remains unchanged when the internally outer gear 18 rotates.

Furthermore, the asymmetric wall thickness configuration 140, 141 of the rotor 14 results in that the axle center of the externally inner gear 16 moves slightly rather than being fixed in the rotation of the externally inner gear 16. The constraint columns 164 of the externally inner gear 16 are confined in the constraint holes 242, thereby moves slightly therein. In the meantime, some of the inner teeth 162 continuously mesh some of the outer teeth 182. In addition, the internally outer gear 18 rotates at reduced speed as a result of the difference in number between the inner teeth 162 and the outer teeth 182. That is, the internally outer gear 18 rotates at a second revolving speed reduced from a first revolving speed of the externally inner gear 16. Note that there is a reduction ratio between the first revolving speed and the second revolving speed; the reduction ratio is defined as a ratio of the number of the outer teeth 182 to a tooth difference (e.g., the difference in number between the inner teeth 162 and the outer teeth 182).

Further, those skilled in the art should understand that the motor with differential matching gear 10 may include a plurality of bearings 27. The bearings 27 are provided to connect different rotating elements and reduce the friction therefore caused during the elements rotate. The inner and outer diameters of the bearings 27 also serve to confine the position of the central axis of the elements or the positional variation of the central axis of the elements.

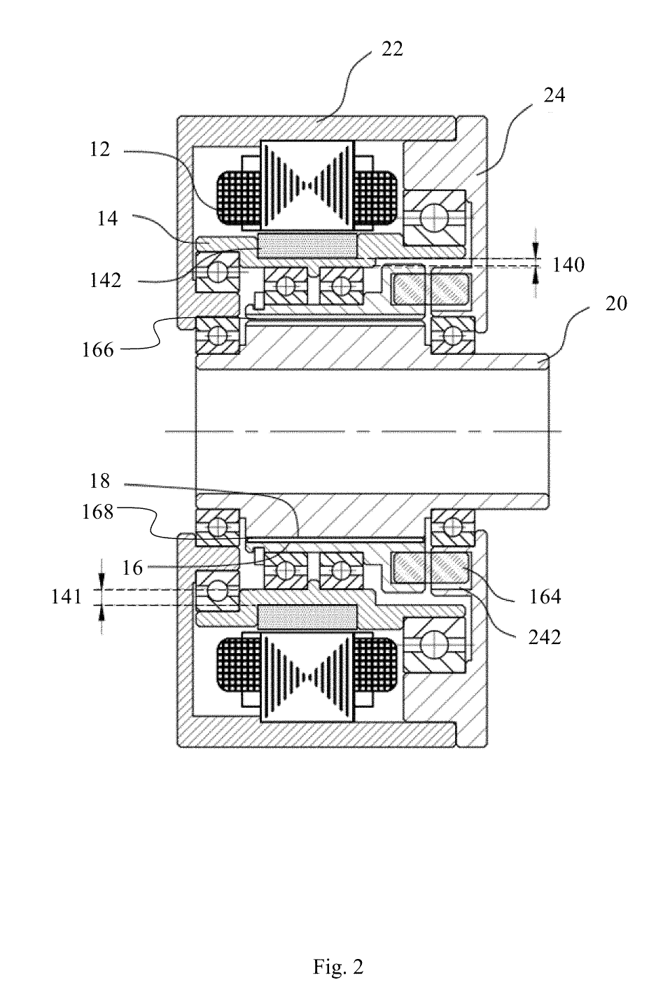

The FIG. 2 shows a schematic cross-sectional view taken along line A-A′ in FIG. 1(b). In FIG. 2, the motor with differential matching gear 10 incorporates the motor housing 22 for accommodating the stator 12, the rotor 14, the externally inner gear 16, the internally outer gear 18, and the output shaft 20.

As demonstrated in FIG. 2, the wall thickness 141 appears to be larger than the wall thickness 140, showing an embodiment of asymmetric wall thickness configuration of the present invention. When the motor with differential matching gear 10 operates, the central axis of the externally inner gear 16 shifts upward due to the larger wall thickness 141. The upward shifting pushes the constraint columns 164 to the upper rim of the constraint holes 242. While the central axis of the externally inner gear 16 is shifting upward, as shown in the position 166, the upper part of the inner teeth 162 departs from the outer teeth 182 of the internally outer gear 18. Meanwhile, as shown in the position 168, the lower part of the inner teeth 162 clenches the outer teeth 182 of the internally outer gear 18. The operation keep the externally inner gear 16 and the internally outer gear 18 partially clenched. This is the reason to have asymmetric wall thickness configuration.

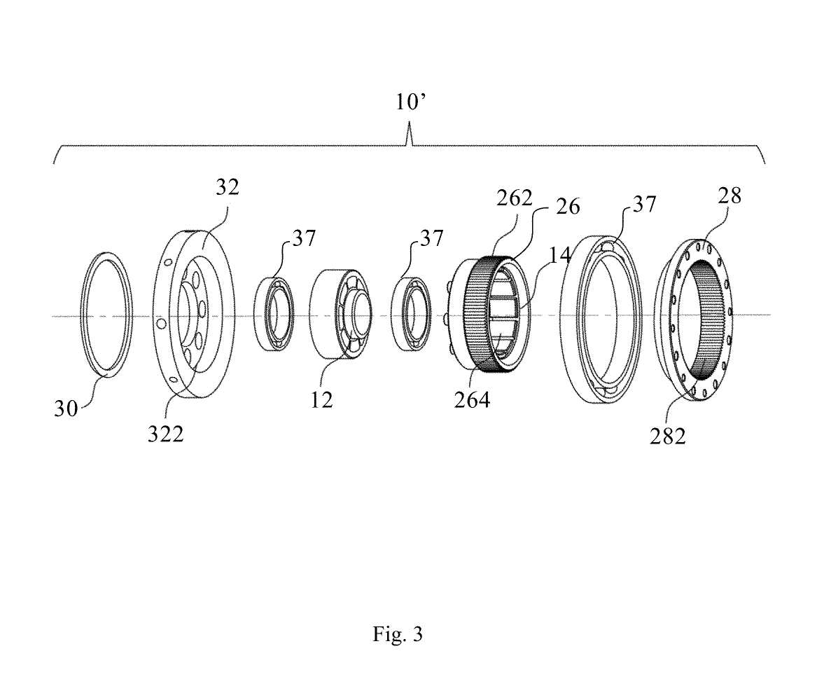

The FIG. 3 shows a schematic exploded view of a motor with differential matching gear according to a second embodiment of the present invention. In FIG. 3, the motor with differential matching gear 10′ has the stator 12, the rotor 14 and the motor 22 (not shown) of the first embodiment. The motor with differential matching gear 10′ further has the internally outer gear 26, the externally inner gear 28, and the output plate 30.

In this embodiment, the motor with differential matching gear 10′ is an outer rotor electric machine.

The internally outer gear 26 is connected to the rotor 14, and has multiple outer teeth 262. It is noted that the rotor 14 dynamically changes the axle center of the internally outer gear 26 by moving the internally outer gear 26 when rotating. In this embodiment, the motor with differential matching gear 10′ further includes a constraint plate 32 with multiple constraint holes 322; multiple constraint columns 264 of the internally outer gear 26 are inserted into the constraint holes 322. The asymmetric wall thickness configuration 140, 141 of the rotor 14 causes the rotation of the constraint columns 264 to be confined in the constraint holes 322. As a result, the internally outer gear 26 rotates eccentrically.

The externally inner gear 28 has multiple inner teeth 282, and is connected to the internally outer gear 26. The outer teeth 262 partially mesh the inner teeth 282 when the internally outer gear 26 rotates. Note that the axle center of the externally inner gear 28 remains unchanged when the externally inner gear 28 rotates.

The way that the internally outer gear 26 and the externally inner gear 28 operate can be referred to above, and is accordingly omitted here. Note that a modified reduction ratio in this embodiment refers to a ratio of the number of the inner teeth 282 to a tooth difference (e.g., the difference in number between the outer teeth 262 and the inner teeth 282).

Further, those skilled in the art should understand that the motor with differential matching gear 10 may include a plurality of bearings 37. The bearings 37 are provided to connect different rotating elements and reduce the friction therefore caused during the elements rotate. The inner and outer diameters of the bearings 37 also serve to confine the position of the central axis of the elements or the positional variation of the central shaft axis of the elements.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A motor with differential matching gear, comprising:
a stator for producing magnetic lines of force;
a rotor having an asymmetric wall thickness configuration and being connected to the stator, wherein the magnetic lines of force cause the rotor to rotate at a first revolving speed;
an externally inner gear having a plurality of inner teeth and being connected to the rotor, wherein the rotor dynamically changes the axle center of the externally inner gear by moving it when rotating;
an internally outer gear having a plurality of outer teeth and being connected to the externally inner gear, wherein the inner teeth partially mesh the outer teeth when the externally inner gear rotates, and wherein the axle center of the internally outer gear remains unchanged when the internally outer gear rotates;
an output shaft connected to the internally outer gear, wherein the internally outer gear causes the output shaft to rotate at a second revolving speed less than the first revolving speed;
a motor housing with an accommodation space for accommodating the stator, the rotor, the externally inner gear, the internally outer gear, and the output shaft; and
an outer housing with a plurality of constraint holes, wherein the externally inner gear has a plurality of constraint columns inserted into the constraint holes.

2. The motor with differential matching gear according to claim 1, wherein there is a difference in number between the inner teeth and the outer teeth, and wherein a ratio of the number of the outer teeth to the difference in number determines a reduction ratio between the first revolving speed and the second revolving speed.

3. The motor with differential matching gear according to claim 1, wherein the stator is coil, and wherein the rotor is field magnet or coil.
